(19) United States
(12) Patent Application Publication
(10) Pub. No.: US 2026/0061822 A1
(43) Pub. Date: Mar. 5, 2026

(54) POWER TRANSMISSION DEVICE

(71) Applicant: Honda Motor Co., Ltd., Tokyo (JP)

(72) Inventor: Toru UBUKATA, Tokyo (JP)

(73) Assignee: Honda Motor Co., Ltd., Tokyo (JP)

(21) Appl. No.: 19/185,168

(22) Filed: Apr. 21, 2025

(30) Foreign Application Priority Data
Aug. 28, 2024 (JP) 2024-147019

(51) Int. Cl. B60K 6/36; B60K 6/383

(52) U.S. Cl. CPC B60K 6/36; B60K 6/383

(57) ABSTRACT

In a power transmission device, a first gear and a second gear composed of helical gears are disposed coaxially to be movable in opposing directions and are respectively engaged with gears connected to a torque generating source. Angles of each helical tooth of the first gear and the second gear are respectively set such that thrust forces in opposite directions are respectively generated at the first gear and the second gear during transmitting, by the first gear and the second gear, a torque from the torque generating source. The first gear and the second gear are fitted coaxially to generate a specific maximum static friction. The first gear and the second gear move in opposing directions in a case where an absolute value of a total value of the thrust forces respectively generated at the first gear and the second gear exceeds an absolute value of the maximum static friction.

### CROSS-REFERENCE TO RELATED APPLICATION

This application claims the priority benefit of Japan application serial no. 2024-147019, filed on Aug. 28, 2024. The entirety of the above-mentioned patent application is hereby incorporated by reference herein and made a part of this specification.

### BACKGROUND

### Technical Field

The disclosure relates to a power transmission device for transmitting power (torque) from a power generating source including a motor of, for example, a hybrid vehicle (HEV) to driving wheels.

### Related Art

In this type of power transmission device, it is known that a first gear and a second gear composed of helical gears are disposed coaxially and accommodated in a case, the first gear and the second gear are respectively engaged with gears connected to a torque generating source such as an engine, a motor, or driving wheels during regeneration, and the angles (orientations) of the helical teeth of the first gear and the second gear are respectively set such that thrust forces in directions (axial direction) opposed to each other are generated at the first gear and the second gear when the first gear and the second gear transmit a torque from the torque generating source (e.g., see Patent Document 1: Japanese Patent No. 6083333). Among the torques from the torque generating source, an acceleration torque, which is a torque in the forward direction with respect to the traveling direction, is transmitted from the engine or motor, and a deceleration torque, which is a torque in the reverse direction with respect to the traveling direction, is transmitted from the driving wheels.

In the above power transmission device, the gear member vibrates in the thrust direction due to variations in rotation of the helical gear, and rattling noise occurs due to collision of the gear member with the case.

Thus, Patent Document 2 (Japanese Patent No. 5812182) proposes a configuration in which an inner wall extending from an outer wall of the case toward the inside of the case is formed in the case, and an elastic member that presses the helical gear toward the inner wall is interposed in a preloaded state between the inner wall and the helical gear.

In addition, Patent Document 3 (Japanese Patent No. 6459370) proposes a power transmission device including a reduction gear having multiple helical gears rotatably supported by bearings, and a limit value of a torque generated in the driving motor during reverse driving of the vehicle is set lower than a limit value of a torque generated in the driving motor during forward driving.

However, in the power transmission devices proposed in Patent Documents 1 to 3, localized strength reduction or wearing occurs due to engagement of the helical gears with each other at specific locations.

### SUMMARY

An embodiment of the disclosure provides a power transmission device (1), in which a first gear (G1) and a second gear (G2) composed of helical gears are disposed coaxially to be movable in at least opposing directions and are accommodated in a case (2). The first gear (G1) and the second gear (G2) are respectively engaged with gears (G4, G6) connected to a torque generating source. Angles of each helical tooth of the first gear (G1) and the second gear (G2) are respectively set such that thrust forces (Fi, Fo) in opposing directions are respectively generated at the first gear (G1) and the second gear (G2) during transmitting, by the first gear (G1) and the second gear (G2), a torque from the torque generating source. The first gear (G1) and the second gear (G2) are fitted coaxially to generate a specific maximum static friction (Fpmax). The first gear (G1) and the second gear (G2) respectively move in opposing directions in a case where an absolute value of a total value of the thrust forces (Fi, Fo) in opposing directions of the first gear (G1) and the second gear (G2) exceeds an absolute value of the maximum static friction (Fpmax).

### BRIEF DESCRIPTION OF THE DRAWINGS

FIG. 1 is a cross-sectional view of a main part of a power transmission device according to the disclosure.

FIG. 2 is a partial side view of a counter shaft end showing a spiral groove formed on an outer circumference of the counter shaft.

FIG. 3 is a schematic cross-sectional view showing forces acting on a first gear and a second gear in the case where a deceleration torque is transmitted to the first gear and the second gear of the power transmission device according to the disclosure.

FIG. 4 is a diagram showing a relationship between thrust forces acting on the first gear and the second gear and a movement amount of the first gear in the case where a deceleration torque or an acceleration torque is transmitted to the first gear and the second gear of the power transmission device according to the disclosure.

FIG. 5 is a schematic cross-sectional view showing forces acting on the first gear and the second gear in the case where an acceleration torque is transmitted to the first gear and the second gear of the power transmission device according to the disclosure.

FIG. 6 is a schematic diagram of tooth surface portions of both gears showing changes in the engagement position between the first gear and a fourth gear.

### DESCRIPTION OF THE EMBODIMENTS

Embodiments of the disclosure provide a power transmission device capable of suppressing localized strength reduction and wearing caused by engagement of gears with each other at specific locations. Other embodiments of the disclosure simplify an overall system configuration and extend a service life by including the power transmission device, and improve energy efficiency of hybrid vehicles and the like by enabling improvement of power transmission efficiency without separately providing devices requiring special power.

An embodiment of the disclosure provides a power transmission device (1), in which a first gear (G1) and a second gear (G2) composed of helical gears are disposed coaxially to be movable in at least opposing directions and are accommodated in a case (2). The first gear (G1) and the second gear (G2) are respectively engaged with gears (G4, G6) connected to a torque generating source. Angles of each helical tooth of the first gear (G1) and the second gear (G2) are respectively set such that thrust forces (Fi, Fo) in opposing directions are respectively generated at the first gear (G1) and the second gear (G2) during transmitting, by the first gear (G1) and the second gear (G2), a torque from the torque generating source. The first gear (G1) and the second gear (G2) are fitted coaxially to generate a specific maximum static friction (Fpmax). The first gear (G1) and the second gear (G2) respectively move in opposing directions in a case where an absolute value of a total value of the thrust forces (Fi, Fo) in opposing directions of the first gear (G1) and the second gear (G2) exceeds an absolute value of the maximum static friction (Fpmax).

According to the power transmission device of the disclosure, the first gear (G1) and the second gear (G2) are fitted coaxially to generate a specific static friction (Fp), and if the absolute value of the total value of the thrust forces (Fi, Fo) in the opposing directions of the first gear (G1) and the second gear (G2) exceeds the absolute value of the maximum static friction (Fpmax), the first gear (G1) and the second gear (G2) respectively move in the opposing directions. Thus, depending on the absolute value of the total value of the thrust forces (Fi, Fo) in the opposing directions of the first gear (G1) and the second gear (G2), the engagement region between the first gear (G1) and the gear engaging with the first gear (G1), and the engagement region between the second gear (G2) and the gear engaging with the second gear (G2) vary in the axial direction. Accordingly, in the power transmission via the first gear (G1) and the second gear (G2) by the power transmission device, the first gear (G1) and the gear engaging with the first gear (G1), and the second gear (G2) and the gear engaging with the second gear (G2) do not always engage at the same location, and the engagement point moves in the axial direction. Thus, despite having a relatively simple configuration, it is possible to suppress localized strength reduction and wearing caused by engagement between the first gear (G1) and the gear engaging with the first gear (G1) and between the second gear (G2) and the gear engaging with the second gear (G2) at specific locations.

Herein, an absolute value of a total value of the thrust forces (Fi, Fo) toward outward directions generated respectively at the first gear (G1) and the second gear (G2) may be defined as a first thrust force, an absolute value of a total value of the thrust forces (Fi, Fo) toward inward directions respectively generated at the first gear (G1) and the second gear (G2) may be defined as a second thrust force, the first gear (G1) and the second gear (G2) may respectively move in the outward directions in a case where the first thrust force exceeds the absolute value of the maximum static friction (Fpmax), and the first gear (G1) and the second gear (G2) may respectively move in the inward directions in a case where the second thrust force exceeds the absolute value of the maximum static friction (Fpmax).

According to this configuration, by setting the first gear and the second gear to move toward directions of the thrust forces respectively generated due to the thrust forces in different directions exceeding the maximum static friction generated between the first gear and the second gear, it becomes possible to move the engagement point of the first gear or the second gear by a change in the direction of the thrust force.

In addition, the first thrust force may be generated during transmission of a torque in a negative direction, and the second thrust force may be generated during transmission of a torque in a positive direction. Alternatively, the first thrust force may be generated during transmission of a torque in a positive direction, and the second thrust force may be generated during transmission of a torque in a negative direction. Herein, the acceleration torque acting on the first gear and the second gear when the vehicle moves forward, or the deceleration torque acting on the first gear and the second gear when the vehicle moves backward is called a positive direction torque. The deceleration torque acting on the first gear and the second gear when the vehicle moves forward, or the acceleration torque acting on the first gear and the second gear when the vehicle moves backward is called a negative direction torque.

According to this configuration, by setting the first gear and the second gear to move respectively due to thrust forces with respectively different orientations generated by torques in different directions, it becomes possible to move the engagement point of the first gear or the second gear by a change in the direction of the torque acting on the first gear and the second gear.

In addition, the first thrust force may exceed the absolute value of the maximum static friction (Fpmax) in a case where a magnitude of the torque in the positive direction or the torque in the negative direction becomes a specific first torque, the second thrust force may exceed the absolute value of the maximum static friction (Fpmax) in a case where a magnitude of a torque in a direction opposite to the first torque becomes a specific second torque, and the first gear (G1) and the second gear (G2) may respectively move in opposing directions.

According to this configuration, by configuring the first gear and the second gear to respectively move in opposing directions if the magnitude of the torque in the positive direction or the torque in the negative direction exceeds a specific torque, since the first gear and the second gear do not move during a low torque equal to or less than the specific torque, decreased responsiveness due to a delay in torque transmission caused by engagement shift can be suppressed especially at the start of driving force transmission. In addition, for example, by applying a torque in the positive direction to the first gear or the second gear which has moved in one direction due to a torque in the negative direction, it becomes possible to move the first gear or the second gear in the other direction and return to the initial position. Furthermore, since the first gear or the second gear moves when the torque becomes high, a high torque is received at a position at which engagement normally does not occur, and localized strength reduction and wearing can be further suppressed.

Furthermore, an absolute value of a total value of thrust forces (Fm, Ff) toward the inward directions applied respectively to the first gear (G1) and the second gear (G2) by the case (2) may be defined as a third thrust force, and the first gear (G1) and the second gear (G2) may respectively move toward the outward directions in a case where the first thrust force exceeds an absolute value of a total value of the absolute value of the maximum static friction (Fpmax) and the third thrust force.

According to this configuration, by setting the first gear and the second gear to respectively move toward the outward directions if the first thrust force exceeds the total value of the maximum static friction and the third thrust force, the first gear or the second gear can be prevented from moving abruptly when the first thrust force exceeds the maximum static friction, and the movement amount of the first gear or the second gear can be controlled with stable behavior. The third thrust force is a preload applied inward from the case to the first gear and the second gear. In addition, since the preload is applied by the case composed of aluminum casting or the like, the preload increases in proportion to the movement amount of the first gear. Thus, in high torque regions, the preload becomes larger, and the support rigidity of the first gear and the second gear can be enhanced. Accordingly, since tilting of the first gear or the second gear can be suppressed in regions in which tilting becomes large, wearing of the first gear or the second gear can be suppressed, and deterioration in vibration and noise associated with tilting of the first gear or the second gear can be suppressed.

In addition, the absolute value of the maximum static friction (Fpmax) may be a value greater than the third thrust force, and the first gear (G1) and the second gear (G2) may respectively move toward the inward directions coaxially in a case where a force totaling the second thrust force and the third thrust force exceeds the absolute value of the maximum static friction (Fpmax).

According to this configuration, by setting the maximum static friction to a value greater than the third thrust force of the preload, it is possible to set a region in which the first gear or the second gear does not move if the second thrust force is not present. Accordingly, since the time (period) during which the first gear or the second gear is moving can be increased, localized wearing of the first gear or the second gear can be more effectively suppressed.

In addition, the power transmission device may include: a hollow first shaft (10) formed on a central axis of the first gear (G1); and a second shaft (3) formed on a central axis of the second gear (G2). The first shaft (10) and the second shaft (3) may be fitted by a press-fitting part (13a) formed by press-fitting an inner circumferential surface of the first shaft (10) and an outer circumferential surface of the second shaft (3) to each other. The maximum static friction (Fpmax) may be a maximum static friction between the inner circumferential surface and the outer circumferential surface at the press-fitting part (13a).

According to this configuration, it becomes possible to move the engagement point of the first gear or the second gear by a relatively simple method of appropriately adjusting the diameter dimensions of the inner circumferential surface and the outer circumferential surface of the press-fitting part.

In addition, the power transmission device may be a power transmission device mounted in a vehicle. The torque generating source may be a power source or a driving wheel of the vehicle. The first gear (G1) may engage with a driving gear (G4) connected to the power source, and the second gear (G2) may engage with a driven gear (G6) connected to the driving wheel. The deceleration torque may be a torque generated during deceleration of the vehicle, and the acceleration torque may be a torque generated during acceleration of the vehicle.

According to this configuration, the first gear or the second gear is set to move respectively by thrust forces with respectively different orientations during deceleration and acceleration of the vehicle. Accordingly, it becomes possible to move the engagement point of the first gear or the second gear respectively during deceleration and acceleration of the vehicle.

In addition, the first thrust force (Fi, Fo) may be generated during transmission of the deceleration torque to the first gear (G1) and the second gear (G2), and the second thrust force (Fi, Fo) may be generated during transmission of the acceleration torque to the first gear (G1) and the second gear (G2).

Generally, acceleration of a vehicle involves a relatively larger torque than deceleration and occurs more frequently. According to this configuration, it becomes possible to reliably return the first gear or the second gear which has moved during deceleration to the initial position during acceleration.

In addition, the vehicle may be a hybrid vehicle including a motor in the power source. The deceleration torque may be a torque generated during regeneration by the motor.

According to this configuration, by using the power transmission device of the disclosure in a vehicle which is a hybrid vehicle and includes a motor in a power source, it becomes possible to perform more regeneration by the motor for improving fuel efficiency while suppressing wearing of the tooth surfaces of the gears included in the power transmission device including the first gear or the second gear.

According to the power transmission device of the embodiments of the disclosure, localized strength reduction and wearing caused by engagement of gears with each other at specific locations can be suppressed.

Hereinafter, embodiments of the disclosure will be described based on the accompanying drawings.

### [Configuration of Power Transmission Device]

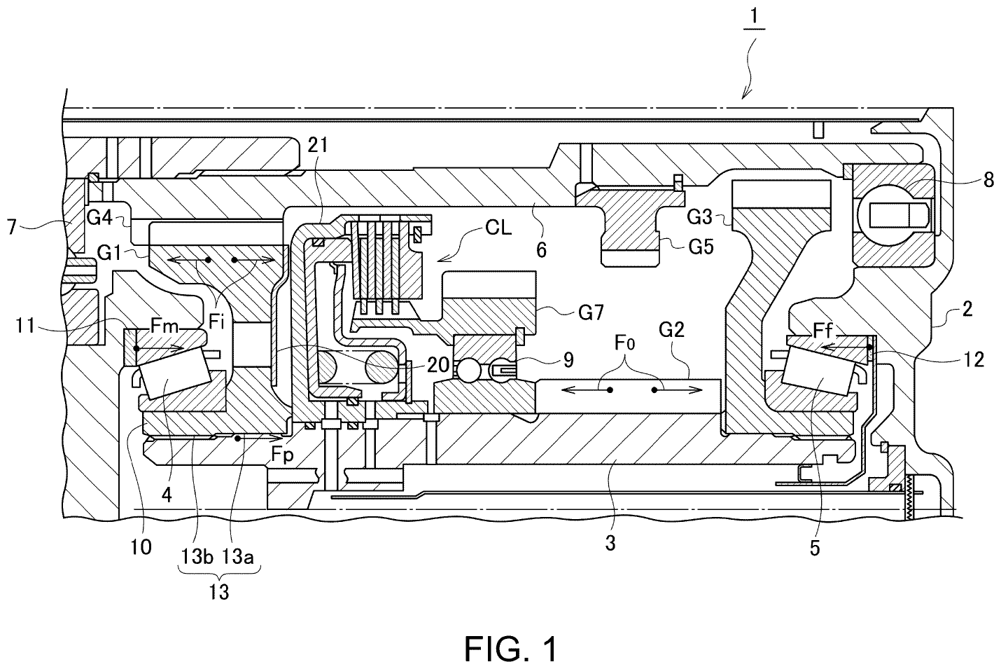

First, the configuration of the main part of a power transmission device according to the disclosure will be described based on FIG. 1.

A power transmission device 1 shown in FIG. 1 is mounted in a hybrid vehicle (HEV) that travels with an engine and an electric motor (not shown) as a driving source (torque generating source), and transmits power outputted from the engine and the electric motor to a pair of left and right driving wheels (not shown). The main configuration thereof is as follows.

Specifically, a first gear G1 and a second gear G2 composed of helical gears are disposed coaxially and accommodated in a case 2 of the power transmission device 1. Herein, the first gear G1 and the second gear G2 are disposed on a hollow counter shaft 3, which is a second shaft. A hollow boss part (first shaft) 10 is formed at the first gear G1, and one axial end (left end in FIG. 1) of the counter shaft 3 is fitted by press-fitting into the hollow boss part 10. In addition, the second gear G2 is integrally formed on the outer circumference of the counter shaft 3. A press-fitting part of the boss part 10 into the counter shaft 3 is labeled with reference sign 13a.

A multi-plate clutch CL is disposed between the first gear G1 and the second gear G2 in the axial direction (left-right direction in FIG. 1) of the counter shaft 3, and a third gear G3 is fitted to the other axial end (right end in FIG. 1) of the counter shaft 3. Herein, the one axial end (left end in FIG. 1) of the counter shaft 3 is rotatably supported by the case 2 via a tapered roller bearing 4 fitted in a radial clearance between the first gear G1 and the case 2, and the other axial end (right end in FIG. 1) of the counter shaft 3 is rotatably supported via a tapered roller bearing fitted in a radial clearance between the third gear G3 and the case 2. The tapered roller bearings 4 and 5 serve the function of receiving axial thrust forces generated at the first gear G1 and the second gear G2. Not limited to the tapered roller bearings 4 and 5, although not shown, it is also possible to adopt a configuration that fits one of the outer ring and the inner ring of a ball bearing movably to allow movement in the thrust direction. In addition, in the power transmission device 1 of this embodiment, with the tapered roller bearings 4 and 5 provided, a specific amount of movement in the thrust direction of the first gear G1, the second gear G2, and the third gear G3 is allowed, and it is possible to shift an engagement range between the first gear G1 and a fourth gear G4 within the range of the specific amount of movement.

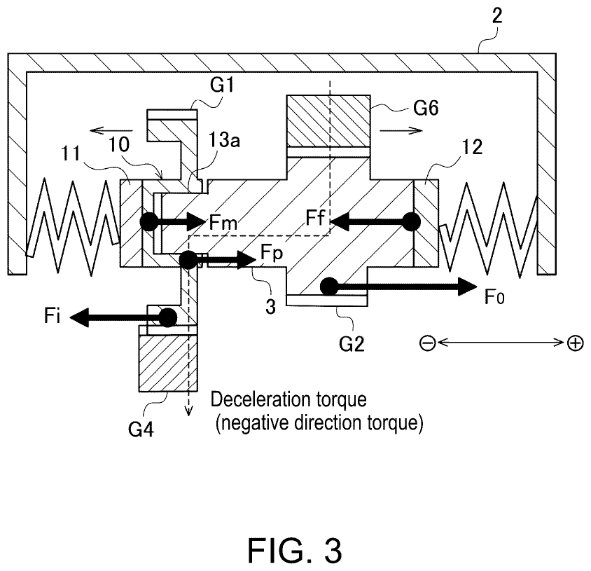

An intermediate shaft 6 is disposed horizontally and parallel to the counter shaft 3 in the case 2, and both axial ends of the intermediate shaft 6 are rotatably supported at the case 2 via ball bearings 7 and 8. A fourth gear G4, which is a driving gear directly connected to a driving motor (not shown), is integrally formed at one axial end (left end in FIG. 1) of the intermediate shaft 6, and the fourth gear G4 engages with the first gear G1. In addition, a parking gear G5 used to secure the vehicle during parking of the vehicle is fixed at the other axial end (right end in FIG. 1) of the intermediate shaft 6, and the parking gear G5 engages with another gear (not shown). Furthermore, a sixth gear G6 (see FIG. 3), which transmits rotation of the driving wheels (not shown) during braking to the second gear G2, engages with the second gear G2, and a regenerative torque from the driving wheels is transmitted to the driving motor (not shown) through the sixth gear G6 with the second gear G2, and the first gear G1 with the fourth gear G4.

The clutch CL selectively rotates a seventh gear G7, which is rotatably supported at the counter shaft 3 by a ball bearing 9. When the clutch CL is ON (connected), power of the engine, which is the driving source, is transmitted to the counter shaft 3 through the seventh gear G7, and when the clutch CL is OFF (disconnected), power from the engine is not transmitted to the counter shaft 3. Herein, a pressing member 20 is attached to the first gear G1 to suppress tilting caused by the thrust force generated at the first gear G1, and with the pressing member 20 contacting a clutch guide 21 of the clutch CL, tilting of the first gear G1 may be suppressed. By suppressing tilting of the first gear G1 in this manner, the natural frequency of the first gear G1 changes, and occurrence of noise and vibration due to resonance is suppressed.

Herein, in this embodiment, although the hardness of the first gear G1, the second gear G2, and the fourth gear (driving gear) G4 is the same, the number of teeth of the fourth gear G4 is set to a value less than the number of teeth of the first gear G1. By setting in this manner, the fourth gear G4 with fewer teeth wears out first, and the cost required for replacing the fourth gear G4 integrally formed with the intermediate shaft 6 can be suppressed. In addition, in this embodiment, the width of the fourth gear G4, which is the driving gear, is set wider than the width of the first gear G1. Thus, even if the first gear G1 moves in the axial direction as described later, an engagement width between the first gear G1 and the fourth gear G4 can be ensured, and power transmission by the first gear G1 and the fourth gear G4 can be reliably performed.

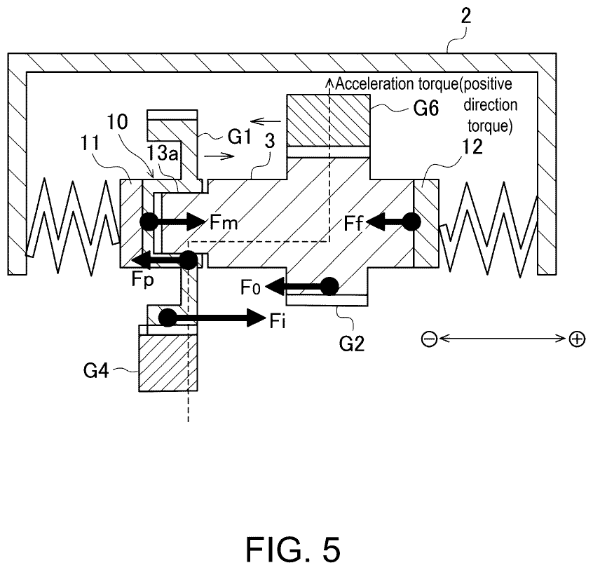

Although the first gear G1 and the second gear G2 coaxially disposed on the counter shaft 3 are composed of helical gears as described above, the angle (orientation) of the helical teeth of each helical gear is set such that thrust forces Fi and Fo in opposing directions (orientations opposite to each other) are generated at the first gear G1 and the second gear G2 when the first gear G1 and the second gear G2 transmit the torque from the torque generating source (refer to FIG. 3 and FIG. 5). Specifically, in the case where the first gear G1 and the second gear G2 transmit a deceleration torque from the torque generating source, as shown in FIG. 3, outward thrust forces (hereinafter referred to as “first thrust forces”) Fi and Fo (in separating directions) are generated at the first gear G1 and the second gear G2, respectively. Conversely, in the case where the first gear G1 and the second gear G2 transmit an acceleration torque from the torque generating source, as shown in FIG. 5, inward thrust forces (hereinafter referred to as “second thrust forces”) Fi and Fo (in approaching directions) are generated at the first gear G1 and the second gear G2, respectively.

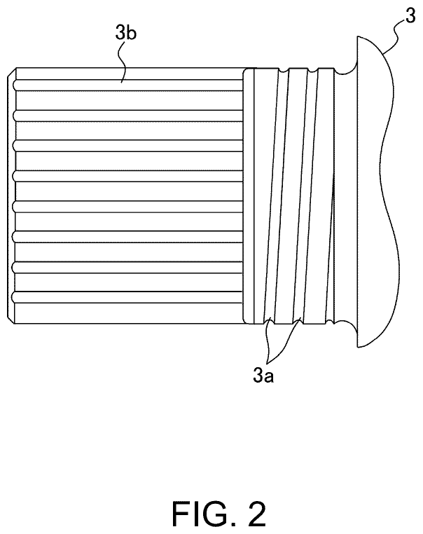

In addition, as described above, at the inner circumferential surface of the hollow boss part 10 of the first gear G1, with respect to the outer circumferential surface of the one axial end (left end in FIG. 1) of the counter shaft 3, the press-fitting part 13a shown in FIG. 1 is press-fitted, and a spline part 13b is spline-fitted. Thus, the counter shaft 3 and the first gear G1 always rotate integrally. A fitting part 13 at which the boss part 10 of the first gear G1 and the one axial end of the counter shaft 3 are fitted together is composed of the press-fitting part 13a and the spline part 13b. In addition, on the outer circumferential part of the counter shaft 3 at the press-fitting part 13a at which the first gear G1 is press-fitted, as shown in FIG. 2, a spiral groove 3a is formed with a specific pitch width. By forming the spiral groove 3a on the outer circumferential part of the press-fitting part 13a of the counter shaft 3 at which the boss part 10 of the first gear G1 is press-fitted, the press-fitting load can be reduced without reducing the width of the portion supporting the load due to press-fitting. In addition, by configuring the torsional direction of the spiral groove 3a as the direction in which oil is discharged during axial movement of the first gear G1, contamination (foreign matter) contained in the oil of the press-fitting part 13a can be effectively discharged via the spiral groove 3a. As shown in FIG. 2, multiple spline grooves 3b are formed at the end of the counter shaft 3 (at a position corresponding to the spline part 13b). In addition, as shown in FIG. 1, the second gear G2 is integrally formed on the outer circumference of the counter shaft 3.

In this embodiment, as shown in FIG. 1, a ring-shaped washer 11 is interposed in an axial clearance between the case 2 and the tapered roller bearing 4, and a preload (first preload) Fm in the second gear G2 direction (rightward in FIG. 1) from the case 2 is applied to the first gear G1 via the washer 11. In addition, a ring-shaped shim 12 is interposed in an axial clearance between the case 2 and the tapered roller bearing 5, and a preload (second preload) Ff in the first gear G1 direction (leftward in FIG. 1) from the case 2 is applied to the second gear G2 via the shim 12. By providing the shim 12, the dimension between the tapered roller bearing 5 and the case 2 can be adjusted, and it becomes possible to easily perform adjustment such that desired preloads are applied to the first gear and the second gear by the elastic force of the case 2 when the case 2 is assembled.

### [Operation of Power Transmission Device]

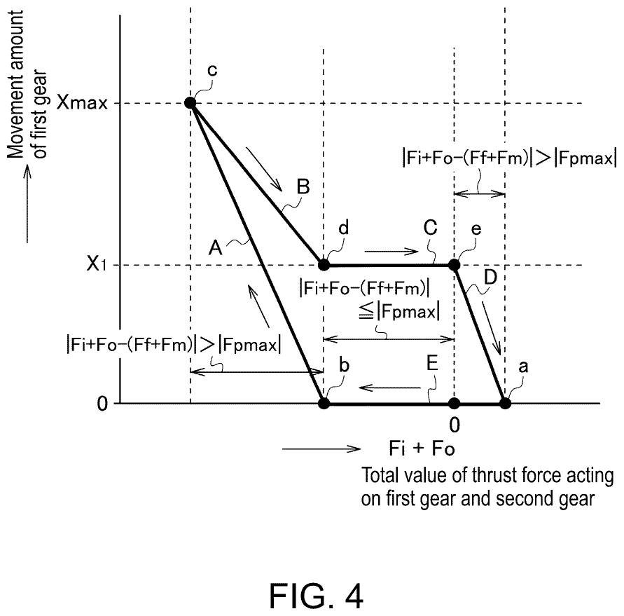

Next, the operation of the power transmission device 1 configured as described above, specifically, the operation in the case where the first gear G1 and the second gear G2 transmit a deceleration torque from the driving wheels during forward movement of the vehicle, and the operation in the case where the first gear G1 and the second gear G2 transmit an acceleration torque from the torque generating source will be described below. Herein, although torque transmission during forward movement of the vehicle is described as an example, similar operations and effects can be achieved during reverse movement of the vehicle (although the direction of the thrust force to be described later will be reversed). FIG. 3 is a schematic cross-sectional view showing forces acting on the first gear G1 and the second gear G2 in the case where the first gear G1 and the second gear G2 transmit a deceleration torque from the driving wheels. FIG. 4 is a diagram (graph) showing a relationship between the movement amount of the first gear G1 and the thrust forces acting on the first gear G1 and the second gear G2 in the case where a deceleration torque or an acceleration torque is transmitted to the first gear G1 and the second gear G2. FIG. 5 is a schematic cross-sectional view showing the forces acting on the first gear G1 and the second gear G2 in the case where an acceleration torque is transmitted to the first gear G1 and the second gear G2. In this specification, an acceleration torque acting on the first gear G1 and the second gear G2 during forward movement of the vehicle, or a deceleration torque acting on the first gear G1 and the second gear G2 during reverse movement of the vehicle is called a positive direction torque (see FIG. 5), and a deceleration torque acting on the first gear G1 and the second gear G2 during forward movement of the vehicle, or an acceleration torque acting on the first gear G1 and the second gear G2 during reverse movement of the vehicle is called a negative direction torque (see FIG. 3). In FIG. 3 and FIG. 5, illustrations of spring-shaped objects between the case 2 and the washer 11 and between the case 2 and the shim 12 schematically represent the elastic force of the case 2, which is an elastic body. In addition, in the graph of FIG. 4, an acceleration torque is shown as (a force in) a positive orientation on the horizontal axis of the graph, and a deceleration torque is shown as (a force in) a negative orientation on the horizontal axis of the graph.

1) Case where the first gear and the second gear transmit a deceleration torque:

In the case where the first gear G1 and the second gear G2 transmit a deceleration torque, which is a torque in a direction opposite to the traveling direction, from the driving wheels, as shown in the schematic diagram of FIG. 3, outward thrust forces Fi and Fo (in directions away from each other) respectively occur simultaneously at the first gear G1 and the second gear G2, which are in the same torque transmission path. In this specification, the absolute value of a total value of the thrust forces Fi and Fo in the outward directions generated respectively at the first gear G1 and the second gear G2 may be referred to as a first thrust force. In addition, the first gear G1 and the second gear G2 receive inward preloads Fm and Ff (in directions approaching each other) respectively from the case 2. Hereinafter, the preload Fm applied from the case 2 to the first gear G1 is called “first preload”, and the preload Ff applied from the case 2 to the second gear G2 via the shim 12 is called “second preload”.

In this embodiment, although the first gear G1 is press-fitted to the counter shaft 3 on which the second gear G2 is integrally formed, the first gear G1 is capable of moving in the outward direction (direction away from the second gear G2 (leftward in FIG. 3)) along the counter shaft 3 by an amount of elastic deformation of the case 2, within the range of a specific amount allowed by the tapered roller bearings 4 and 5. Herein, a friction (static friction Fp, maximum static friction Fpmax, kinetic friction Fpmov), which is the frictional resistance force generated at the press-fitting part 13a of the first gear G1 to the counter shaft 3 when the first gear G1 moves in the outward direction, acts in a direction opposite to the movement direction of the first gear G1.

Thus, if the acting direction of the force in the rightward direction in FIG. 3 is defined as “+”, and the acting direction of the force in the opposite leftward direction is defined as “−”, in the case where the first gear G1, which is movable axially, is stationary without moving, a relationship represented by the following formula is established between the first thrust force (Fi+Fo) and the first preload Fm acting on the first gear G1, the static friction Fp at the press-fitting part 13a of the first gear G1, and the second preload Ff acting on the second gear G2.

$$Fi + Fo = Fp + Fm + Ff \qquad ( 1 )$$

Herein, if the maximum static friction when slippage (relative displacement in the thrust direction between the first gear G1 and the second gear G2) occurs at the press-fitting part 13a is defined as Fpmax, since a relationship of Fp≤Fpmax is present between the static friction Fp and the maximum static friction Fpmax, while the first gear G1 is stationary without moving, a relationship represented by the following formula is established.

$$\vert Fi + Fo - ( Ff + Fm ) \vert \leq \vert Fpmax \vert \qquad ( 2 )$$

In other words, at points a to b along a straight line E shown in FIG. 4, the difference between the first thrust force (Fi+Fo) acting on the first gear G1 and the second gear G2 due to transmission of the deceleration torque to the first gear G1 and the second gear G2, and the total value (Ff+Fm) of the first preload Fm, which is the biasing force in the +direction acting from the case 2 on the first gear G1, and the second preload Ff, which is the biasing force in the −direction acting from the case 2 on the second gear G2, is less than or equal to the maximum static friction Fpmax of the press-fitting part 13a, so the first gear G1 remains stationary without moving.

Then, if the following magnitude relationship is established between the first thrust force (Fi+Fo) acting on the first gear G1, the first preload Fm, and the maximum static friction Fpmax of the press-fitting part 13a, and the second preload Ff acting on the second gear G2:

$$\vert Fi + Fo - ( Ff + Fm ) \vert > \vert Fpmax \vert \qquad ( 3 )$$

the first gear G1 and the second gear G2 move outward from each other (in directions away from each other).

In other words, at points b to c shown in FIG. 4, if the difference between the first thrust force (Fi+Fo) acting on the first gear G1 and the second gear G2 due to transmission of the deceleration torque to the first gear G1 and the second gear G2, and the total value (Ff+Fm) of the preloads acting on the first gear G1 and the second gear G2, becomes greater than the maximum static friction Fpmax of the press-fitting part 13a, the first gear G1 moves in the outward direction (leftward in FIG. 3, away from the second gear G2), and the movement amount x thereof increases along the straight line A shown in FIG. 4. Then, at point c shown in FIG. 4 at which the first thrust force (Fi+Fo) acting on the first gear G1 is maximum, the movement amount x in the outward direction of the first gear G1 shows a maximum value xmax.

Then, from the state where the first gear G1 has moved to point c shown in FIG. 4, if the deceleration torque transmitted to the first gear G1 decreases, the first gear G1 moves inward (in a direction approaching the second gear G2) from point c to point d along a straight line B in FIG. 4, due to the difference between the first thrust force (Fi+Fo) acting on the first gear G1 and the second gear G2, and the total value (Ff+Fm) of the preloads acting on the first gear G1 and the second gear G2. In other words, while the difference between the first thrust force (Fi+Fo) acting on the first gear G1 and the second gear G2, and the total value (Ff+Fm) of the preloads acting on the first gear G1 and the second gear G2 is greater than the kinetic friction Fpmov acting on the press-fitting part 13a, that is, while the relationship of the following formula is established:

$$\vert Fi + Fo - ( Ff + Fm ) \vert > \vert Fpmov \vert \qquad ( 4 )$$

the first gear G1 moves inward.

Then, at the time point at which the relationship of the following formula is established:

$$\vert Fi + Fo - ( Ff + Fm ) \vert = \vert Fpmov \vert \qquad ( 5 )$$

the inward movement of the first gear G1 stops. This stopped state of the first gear G1 continues until the first thrust force (Fi+Fo) generated at the first gear G1 and the second gear G2 decreases to 0, that is, from point d until point e along a straight line C shown in FIG. 4.

2) Case where the first gear and the second gear transmit an acceleration torque:

On the other hand, in the case where the first gear G1 and the second gear G2 transmit an acceleration torque, which is a torque in the forward direction with respect to the traveling direction, from the torque generating source, as shown in FIG. 5, inward thrust forces Fi and Fo (in directions approaching each other) are generated at the first gear G1 and the second gear G2, respectively. In this specification, the absolute value of a total value of the thrust forces Fi and Fo in the inward directions generated respectively at the first gear G1 and the second gear G2 may be referred to as a second thrust force. In addition, the first gear G1 and the second gear G2 respectively receive inward preloads Fm and Ff (in directions approaching each other) from the case 2.

Thus, if the acting direction of the force in the rightward direction in FIG. 5 is defined as “+”, and the acting direction of the force in the opposite leftward direction is defined as “−”, when an acceleration torque is transmitted from the torque generating source such as an engine or a motor to the first gear G1 and the second gear G2, in the case where the first gear G1, which is movable axially, remains stationary without moving, a relationship represented by the following formula is established between the first thrust force (Fi+Fo) and the first preload Fm acting on the first gear G1, the maximum static friction Fpmax of the press-fitting part 13a, and the second preload Ff acting on the second gear G2.

$$\vert Fi + Fo - ( Ff + Fm ) \vert \leq \vert Fpmax \vert \qquad ( 6 )$$

On the other hand, if the magnitude relationship of the following formula is established:

$$\vert Fi + Fo - ( Ff + Fm ) \vert > \vert Fpmax \vert \qquad ( 7 )$$

the first gear G1 moves inward (in a direction approaching the second gear G2) (with respect to the second gear G2 (counter shaft 3)).

In other words, the first gear G1 moves inward along a straight line D from point e in FIG. 4 to return to the initial position (point a shown in FIG. 4).

As described above, in the power transmission device 1 according to this embodiment, the first gear G1 and the second gear G2 are fitted coaxially by press-fitting at the press-fitting part 13a to generate a specific friction (static friction Fp, maximum static friction Fpmax, kinetic friction Fpmov). When outward thrust forces Fi and Fo (in directions away from each other) act on the first gear G1 and the second gear G2 respectively, since the first gear G1 is configured to move outward, the engagement region between the first gear G1 and the fourth gear G4 varies in the axial direction. Thus, the first gear G1 and the fourth gear G4 do not always engage at the same location, and the engagement point moves in the axial direction. In this embodiment, although it has been described as an example that only the first gear G1 moves outward (in a direction away from the second gear G2), alternatively, it is also possible to adopt a configuration in which both the first gear G1 and the second gear G2 are capable of moving in directions opposed to each other.

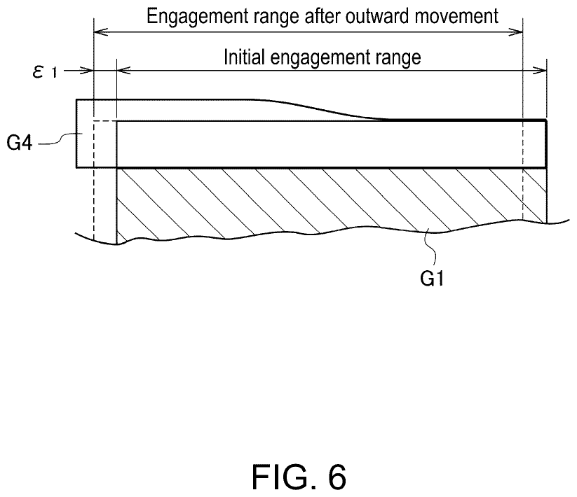

Thus, according to this embodiment, it is possible to obtain the effect of suppressing localized strength deficiency and wearing caused by the engagement of the first gear G1 and the fourth gear G4 at a specific location. Herein, FIG. 6 is a schematic diagram of tooth surface portions of both gears showing a change in the engagement position between the first gear G1 and the fourth gear G4. When the first thrust forces (outward thrust forces) Fi and Fo during transmission of a deceleration torque act on the first gear G1 and the second gear G2, as shown in the figure, the first gear G1 moves outward from a solid line position to a broken line position, and the engagement region between the first gear G1 and the fourth gear G4 moves by ε1 in the outward direction (leftward in FIG. 6). As a result, the engagement region between the first gear G1 and the fourth gear G4 alternately varies in the axial direction, the first gear G1 and the fourth gear G4 do not always engage at the same location, and the engagement point moves in the axial direction.

Then, in the case where the torque transmitted to the first gear G1 and the second gear G2 is small, and the thrust forces Fi and Fo acting on the first gear G1 and the second gear G2 are small, since the first gear G1 and the second gear G2 do not move, decreased responsiveness caused by engagement shift during driving force transmission can be prevented. In particular, it is possible to prevent decreased responsiveness caused by a delay in torque transmission due to a change in the engagement position at the start of driving force transmission. Conversely, in the case where the torque transmitted to the first gear G1 and the second gear G2 is large, the movement amount of the first gear G1 and the second gear G2 increases, a high torque is received at a position at which engagement normally does not occur, and localized strength reduction and wearing of the tooth surface can be suppressed.

In addition, in this embodiment, the first gear G1 and the fourth gear G4 are configured with the same hardness, and since the number of teeth of the fourth gear G4 is configure to be less than the number of teeth of the first gear G1, the replacement cost of the fourth gear G4 which has fewer teeth and wears out first can be suppressed. In addition, since the width of the fourth gear is set wider than the width of the first gear G1, even if the first gear G1 moves in the axial direction, the engagement width between the first gear G1 and the fourth gear G4 can be ensured, and power transmission by the first gear G1 and the fourth gear G4 can be reliably performed.

In addition, in this embodiment, since the spiral groove 3a is formed on the outer circumferential part of the press-fitting part 13a of the counter shaft 3 at which the first gear G1 is press-fitted, the press-fitting load of the first gear G1 can be appropriately adjusted without reducing the width supporting the load. Also, since the torsional direction of the spiral groove 3a is configured in the direction in which oil is discharged during axial movement of the first gear G1, contamination (foreign matter) contained in the oil can be effectively discharged.

Furthermore, in this embodiment, since the pressing member 20 is attached to the first gear G1 to suppress tilting of the first gear G1 caused by a thrust force generated at the first gear G1, tilting of the first gear G1 is prevented. Also, by suppressing tilting of the first gear G1 in this manner, the natural frequency of the first gear G1 changes, and occurrence of noise and vibration due to resonance is suppressed.

The disclosure is not limited to the embodiment described above, and various modifications are possible within the scope of the technical concept described in the claims, specification, and drawings. For example, in the above embodiment, the case of the power transmission device in which the first gear and the second gear are accommodated has been described as one case 2, but the case may also be a configuration composed of multiple members (multiple divided cases) combined together. In that case, a preload is applied to the first gear and the second gear from each of the members (each divided case).

What is claimed is:

1. A power transmission device, in which a first gear and a second gear composed of helical gears are disposed coaxially to be movable in at least opposing directions and are accommodated in a case,
the first gear and the second gear are respectively engaged with gears connected to a torque generating source, and
angles of each helical tooth of the first gear and the second gear are respectively set such that thrust forces in opposing directions are respectively generated at the first gear and the second gear during transmitting, by the first gear and the second gear, a torque from the torque generating source, wherein
the first gear and the second gear are fitted coaxially to generate a specific maximum static friction, and
the first gear and the second gear respectively move in opposing directions in a case where an absolute value of a total value of the thrust forces in opposing directions of the first gear and the second gear exceeds an absolute value of the maximum static friction.

2. The power transmission device according to claim 1, wherein
an absolute value of a total value of the thrust forces toward outward directions generated respectively at the first gear and the second gear is defined as a first thrust force,
an absolute value of a total value of the thrust forces toward inward directions respectively generated at the first gear and the second gear is defined as a second thrust force,
the first gear and the second gear respectively move in the outward directions in a case where the first thrust force exceeds the absolute value of the maximum static friction, and
the first gear and the second gear respectively move in the inward directions in a case where the second thrust force exceeds the absolute value of the maximum static friction.

3. The power transmission device according to claim 2, wherein
the first thrust force is generated during transmission of a torque in a negative direction, and the second thrust force is generated during transmission of a torque in a positive direction.

4. The power transmission device according to claim 2, wherein
the first thrust force is generated during transmission of a torque in a positive direction, and the second thrust force is generated during transmission of a torque in a negative direction.

5. The power transmission device according to claim 3, wherein
the first thrust force exceeds the absolute value of the maximum static friction in a case where a magnitude of the torque in the positive direction or the torque in the negative direction becomes a specific first torque,
the second thrust force exceeds the absolute value of the maximum static friction in a case where a magnitude of a torque in a direction opposite to the first torque becomes a specific second torque, and
the first gear and the second gear respectively move in opposing directions.

6. The power transmission device according to claim 4, wherein
the first thrust force exceeds the absolute value of the maximum static friction in a case where a magnitude of the torque in the positive direction or the torque in the negative direction becomes a specific first torque,
the second thrust force exceeds the absolute value of the maximum static friction in a case where a magnitude of a torque in a direction opposite to the first torque becomes a specific second torque, and
the first gear and the second gear respectively move in opposing directions.

7. The power transmission device according to claim 2, wherein
an absolute value of a total value of thrust forces toward the inward directions applied respectively to the first gear and the second gear by the case is defined as a third thrust force, and
the first gear and the second gear respectively move toward the outward directions in a case where the first thrust force exceeds a total value of the absolute value of the maximum static friction and the third thrust force.

8. The power transmission device according to claim 7, wherein
the absolute value of the maximum static friction is a value greater than the third thrust force, and
the first gear and the second gear respectively move toward the inward directions coaxially in a case where a force totaling the second thrust force and the third thrust force exceeds the absolute value of the maximum static friction.

9. The power transmission device according to claim 1, comprising:
a first shaft formed on a central axis of the first gear, at least a part of the first shaft being hollow; and
a second shaft formed on a central axis of the second gear, wherein
the first shaft and the second shaft are fitted by a press-fitting part formed by press-fitting an inner circumferential surface of the first shaft and an outer circumferential surface of the second shaft to each other, and
the maximum static friction is a maximum static friction between the inner circumferential surface and the outer circumferential surface at the press-fitting part.

10. The power transmission device according to claim 3, wherein
the power transmission device is a power transmission device mounted in a vehicle,
the torque generating source is a power source or a driving wheel of the vehicle,
the first gear engages with a driving gear connected to the power source, and the second gear engages with a driven gear connected to the driving wheel, and
a deceleration torque is a torque generated during deceleration of the vehicle, and an acceleration torque is a torque generated during acceleration of the vehicle.

11. The power transmission device according to claim 10, wherein
the first thrust force is generated during transmission of the deceleration torque to the first gear and the second gear, and the second thrust force is generated during transmission of the acceleration torque to the first gear and the second gear.

12. The power transmission device according to claim 10, wherein
the vehicle is a hybrid vehicle comprising a motor in the power source, and
the deceleration torque is a torque generated during regeneration by the motor.

13. The power transmission device according to claim 10, wherein
hardnesses of the first gear and the driving gear are the same, and the number of teeth of the first gear is less than the number of teeth of the driving gear.

14. The power transmission device according to claim 10, wherein
a tooth width of the driving gear is wider than a tooth width of the first gear.

15. The power transmission device according to claim 4, wherein
the power transmission device is a power transmission device mounted in a vehicle,
the torque generating source is a power source or a driving wheel of the vehicle,
the first gear engages with a driving gear connected to the power source, and the second gear engages with a driven gear connected to the driving wheel, and
a deceleration torque is a torque generated during deceleration of the vehicle, and an acceleration torque is a torque generated during acceleration of the vehicle.

16. The power transmission device according to claim 15, wherein
the first thrust force is generated during transmission of the deceleration torque to the first gear and the second gear, and the second thrust force is generated during transmission of the acceleration torque to the first gear and the second gear.

17. The power transmission device according to claim 15, wherein
the vehicle is a hybrid vehicle comprising a motor in the power source, and
the deceleration torque is a torque generated during regeneration by the motor.

18. The power transmission device according to claim 15, wherein
hardnesses of the first gear and the driving gear are the same, and the number of teeth of the first gear is less than the number of teeth of the driving gear.

19. The power transmission device according to claim 9, wherein
a spiral groove is formed at the press-fitting part, and a torsional direction of the spiral groove is configured in a direction in which oil is discharged through the spiral groove during movement of the first gear.

20. The power transmission device according to claim 1, wherein
a pressing member is provided to bring the first gear into contact with another member during tilting of the first gear.
